(19) United States
(12) Patent Application Publication
(10) Pub. No.: US 2014/0067671 A1
(43) Pub. Date: Mar. 6, 2014

(54) Virtual Gift Card

(71) Applicants: Terressa Genevieve Jean DeHaven, Mesa, AZ (US); Brad David DeHaven, Mesa, AZ (US)

(72) Inventors: Terressa Genevieve Jean DeHaven, Mesa, AZ (US); Brad David DeHaven, Mesa, AZ (US)

(73) Assignee: eBay, Inc., San Jose, CA (US)

(21) Appl. No.: 13/601,474

(22) Filed: Aug. 31, 2012

(51) Int. Cl. G06Q 20/40

(52) U.S. Cl. 705/44

(57) ABSTRACT

A simple, easy, and convenient way to give gift cards is provided. A virtual gift card can be purchased by a user via a mobile device or computer of the user and the gift card can be given to a recipient when the recipient checks in with merchant via a social network, such as Facebook. The merchant can accept payment via a payment provider, such as Paypal, Inc. Any of the recipient's social network friends can purchase the virtual gift card for the recipient, such as via an app on a mobile device of the friend. When the recipient begins a payment transaction for goods being purchased, then the virtual gift card can be used to at least partially pay for products purchased by the recipient. The virtual gift card can appear via a merchant device and/or via a mobile device of the recipient.

### BACKGROUND

1. Technical Field

The present disclosure generally relates to electronic commerce and, more particularly, relates to a virtual gift card that can be given from one member of a social network to another member of the social network.

2. Related Art

Gift cards are commonly given from one person to another person. Generally, gift cards look and function much like credit cards. Gift cards can be purchased at many large retail stores, such as Target, Walmart, and K-Mart. Typically, gift cards are given as presents for birthdays, Christmas, and the like. An advantage of giving a gift card is that the giver does not have to decide what the recipient would like to have as a present. Also, when giving the gift card, the giver typically does not have to spend much time shopping for the present. Thus, gift cards are very easy and convenient to purchase and give.

The recipient can purchase just about any product that the recipient wants with the gift card. Gift cards are accepted at many different stores. Indeed, some gift cards (gift cards issued by credit card companies, for example) are almost universally accepted. Thus, at least in many instances, gift cards tend to make very good gifts.

Although gift cards are an easy and convenient present to give, their use does require some forethought. The giver must typically travel to a retail store and purchase the gift card in advance of giving the gift card to the recipient. Sometimes, it is inconvenient or impossible for the giver to travel to the retail store. For example, weather conditions, lack of transportation, or other factors may make it difficult for the giver to travel to the retail store to purchase the gift card. Sometimes, the giver may not even be aware of the need to give a present until it is too late to purchase the gift card at a retail store.

### BRIEF DESCRIPTION OF THE DRAWINGS

FIG. 1 is a block diagram of a system for facilitating the sale and use of virtual gift cards, in accordance with an embodiment;

FIG. 2 is a flow chart showing a method for facilitating the sale and use of virtual gift cards, according to an embodiment;

FIG. 3 is a flow chart showing further detail of the method for facilitating the sale and use of virtual gift cards, according to an embodiment; and

FIG. 4 is a block diagram of an example of a computer that is suitable for use in the system for facilitating the sale and use of virtual gift cards, according to an embodiment.

### DETAILED DESCRIPTION

A simple, easy, and convenient way to purchase and give gift cards is provided. According to an embodiment, the gift cards can be virtual gift cards. A virtual gift card can be purchased by a person, e.g., a giving user, who wants to give a gift. The virtual gift card can be purchased after the giving user is alerted that the recipient, e.g., the receiving user, has checked in with a merchant via a social network. For example, the receiving user can check in with Walmart via Facebook to alert the receiving user's friends, including the giving user, that the receiving user is shopping.

The virtual gift card can be purchased via a mobile device or computer of the giving user. Thus, the giving user can purchase the virtual gift card from wherever the giving user is when the giving user is alerted that the receiving user has checked in with the merchant. The giving user does not have to go somewhere, such as to a retail store, to purchase the virtual gift card.

The virtual gift card can be given to the receiving user at any time after the giving user purchases the virtual gift card. For example, the virtual gift card can be given to the receiving user by notifying the receiving user of the virtual gift card via a mobile device of the receiving user. For example, a text message, email, or voice message can notify the receiving user of the virtual gift card as the receiving user shops with the merchant.

As a further example, the virtual gift card can be given to receiving user when the receiving user offers payment for products purchased from the merchant. A merchant device, such as a point of sale checkout system, can alert both the receiving user and a checkout clerk of the virtual gift certificate at the checkout counter. For example, the virtual gift card can be presented on a receipt printed by the merchant device and the receipt can show that the virtual gift card was used, at least in part, to pay for the purchase. The virtual gift card can be displayed on a monitor of the merchant device or on a monitor of a user's mobile device. Thus, the virtual gift card can be automatically used to pay, at least in part, for the purchase.

Rather than automatically applying the virtual gift card to the purchase, the receiving user can be notified of the virtual gift card and can be provided the option of applying the virtual gift card to the purchase. Thus, the virtual gift card can be applied to the purchase if the receiving user desires.

The merchant can accept payment via a payment provider, such as Paypal, Inc. The merchant can participate in a payment service such as Paypal, Paypal Here, or Bill Me Later. The merchant can participate in any payment service or methodology that facilitates the use of the virtual gift card, as discussed herein.

The giving user can pay for the virtual gift card via the payment provider. Generally, any of the receiving user's social network friends can be informed that the receiving user is shopping at a store of the merchant. One or more of the receiving user's social network friends can purchase the virtual gift card for the receiving user and can thus be a giving user. The giving user(s) can pay for the virtual gift card via the payment provider, a credit card, or any other means. Thus, a plurality of the receiving user's social network friends can cooperate and can contribute to the cost of the virtual gift card. A payment server of the payment provider can automatically aggregate a plurality of contributions to apply to the purchase by a group of a single virtual gift card.

Since the gift cards can be virtual gift cards, no physical gift card or other physical item is required. However, the virtual gift cards can be embodied or represented by physical gift card, security token, or any other physical device. For example, the giving user can purchase a virtual gift card and have the amount of the virtual gift card added to an existing physical gift card of the receiving user. Possession of the physical device can either be required or not be required for use of the virtual gift card.

Thus, giving of the virtual gift card can require very little, if any, forethought. The giving user is not required to travel to a retail store and to purchase the virtual gift card in advance of giving the virtual gift card to the receiving user. Rather, once the giving user is aware that the receiving user is checked in with a merchant, the giving user can merely use an app, such as on a giving user's mobile device, to request and pay for the virtual gift card for the receiving user. In this manner, the giving user can give a virtual gift card to the receiving user even when it is inconvenient or impossible for the giving user to purchase the virtual gift card at a retail store or when the giving user is not aware of the need to give the virtual gift card or does not desired to give the virtual gift card until it is too late to purchase the virtual gift card at a retail store.

According to an embodiment, a system can comprise a memory for storing account information for a plurality of users. The account information can include information regarding a giving user and a receiving user. One or more processors can be operable to receive a first incoming communication including an indication of a desire of the giving user to give a virtual gift card to the receiving user. The one or more processors can be further operable to access a giving user's account and determine, at least in part from the giving user's account, if the giving user is authorized to give the virtual gift card. The one or more processors can be further operable to send a first outgoing communication that includes a notification that the receiving user has been given the virtual gift card, if the giving user is authorized to give the virtual gift card.

The one or more processors can be further operable to receive a second incoming communication that includes an indication of a desire of a person to perform a purchase transaction with the virtual gift card. The one or more processors can be further operable to send a second outgoing communication authorizing the purchase transaction if the person is the receiving user. The second incoming communication can include a personal identification number (PIN) of the person and the second outgoing communication can authorize the person to complete the purchase transaction based, at least in part, on whether the PIN is a PIN of the receiving user.

Determining if the giving user is authorized to give the virtual gift card can comprise, at least in part, determining if the giving user has sufficient funds or sufficient credit to facilitate giving the virtual gift card. The virtual gift card can be subject to various limitations, as discussed below. For example, the virtual gift card can be usable only with the merchant where the receiving user was checked in with the social network when the virtual gift card was given. As a further example, the virtual gift card can be usable only for a limited time, e.g., one, two, or three hours, after the virtual gift card was given.

The giving user can specify a money amount, a receiving user, and any desired limitations or suggestions regarding the virtual gift card. Such limitations can include limitations regarding the store(s) where the virtual gift card can be used, the product(s) that can be purchased with the virtual gift card, an expiration time/date for the virtual gift card, the geographic area(s) where the virtual gift card can be used, and/or the time(s) at which the virtual gift card can be used. For example, the virtual gift card can be limited to use at a specified store, a specified group of stores, or a specified chain of stores. The virtual gift card can be limited to use for purchasing a specified product or type of product. The virtual gift card can be limited to use geographically. For example, the virtual gift card can be limited to use within a specified city or group of cities, within a specified state or group of states, within a specified country or group of countries, and/or at any location or group of locations. Use of the virtual gift card can be limited temporarily. For example, the virtual gift card can be limited to use on weekdays, on weekends, from 11:00 AM to 1:00 on weekdays, and/or at any other time.

The first outgoing communication, the second outgoing communication, or both the first outgoing communication and the second outgoing communication can include a message from the giving user to the receiving user. The message can include a greeting, such as “Happy Birthday!” or the like. The message can include a notification of any limitation or suggestions associated with the virtual gift card.

According to an embodiment, the giving user and the receiving user can both be members of a same social network. For example, the giving user and the receiving user can both be members of Facebook. The one or more processors can be operable to determine, at least in part from the social network, what merchant the receiving user is checked in with via the social network. Thus, the payment server can determine where the receiving user is shopping. The one or more processors can be operable provide authorization for the receiving user to complete a purchase transaction using the virtual gift card only with the merchant which the receiving user was checked in with via the social network when the first outgoing communication was sent.

According to an embodiment, the giving user and the receiving user can both be users of the same payment provider. For example, the giving user and the receiving user can both be users of Paypal, Inc. According to an embodiment, the giving user and the receiving user can be users of different payment providers.

According to an embodiment, a method can comprise storing, in a memory, account information for a plurality of users. The account information can include information regarding a giving user and a receiving user. The method can further comprise receiving, electronically by one or more processors, a first incoming communication including an indication of a desire of the giving user to give a virtual gift card to the receiving user. The method can further comprise accessing, by the one or more processors, a giving user's account. The method can further comprise determining, by the one or more processors and at least in part from the giving user's account, if the giving user is authorized to give the virtual gift card. The method can further comprise sending, by the one or more processors, a first outgoing communication including a notification that the receiving user has been given the virtual gift card, if the giving user is authorized to purchase and/or give the virtual gift card. According to an embodiment, a computer program product comprising a non-transitory computer readable medium having computer readable and executable code can instruct one or more processors to perform the method.

According to an embodiment, a giving user is notified when a receiving user is at a merchant location, such as when the receiving user checks in through a social network. This notification allows the giving user to purchase a gift card for the receiving user while the receiving user is at the merchant location and also facilitates notification of the receiving user and/or the merchant that the gift card gift card has been given. According to an embodiment, the gift card can be automatically applied during checkout.

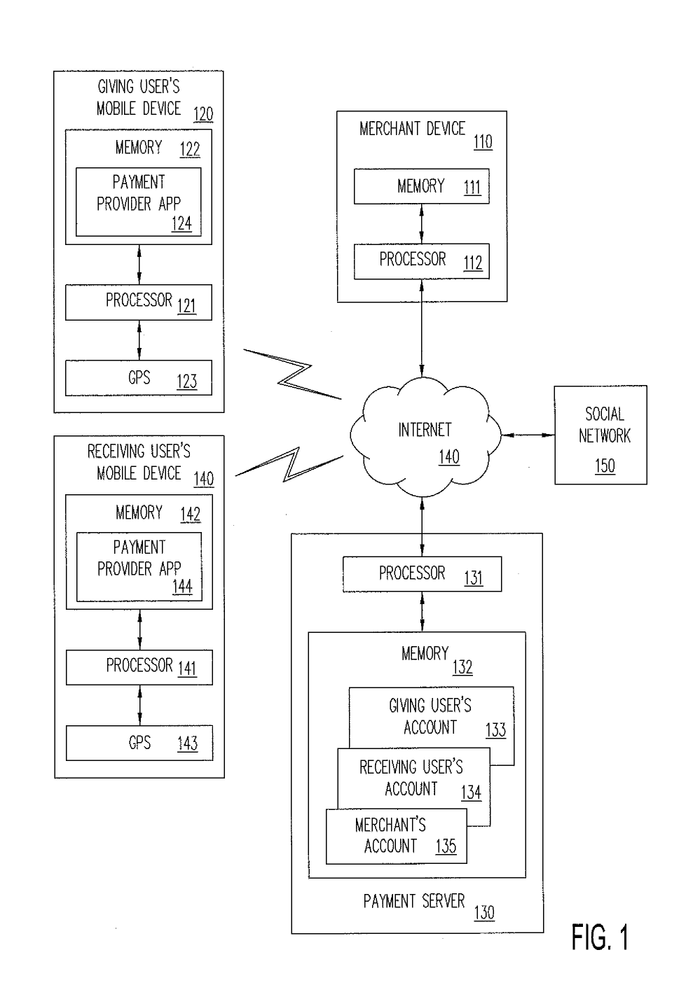

FIG. 1 is a block diagram of a system for facilitating the sale and use of virtual gift cards, in accordance with an embodiment. The system can include a merchant device 110. The merchant device 110 can be a merchant checkout terminal, a computer, and/or a server, for example. The merchant device 110 can include a memory 111 and a processor 112.

The system can include a giving user's mobile device 120. The giving user's mobile device 120 can be carried by the giving user. The giving user's mobile device 120 can be a cellular telephone, a smart telephone, a hand held computer, a laptop computer, a notebook computer, or a tablet computer, for example. The giving user's mobile device 120 can include a processor 121, a memory 122, and a global positioning system (GPS) 123.

The memory 122 can contain a payment provider app 124. The payment provider app 124 can facilitate the giving and receiving of virtual gift cards. The payment provider app 124 can facilitate other payment provider functionality, such as payment provider account control and monitoring, as well as payment.

The system can include a receiving user's mobile device 140. The receiving user's mobile device 140 can be carried by the receiving user. The receiving user's mobile device 140 can be a cellular telephone, a smart telephone, a hand held computer, a laptop computer, a notebook computer, or a tablet computer, for example. The receiving user's mobile device 140 can include a processor 141, a memory 142, and a global positioning system (GPS) 143.

The memory 142 can contain a payment provider app 144. The payment provider app 144 can facilitate the giving and receiving of virtual gift cards. The payment provider app 144 can facilitate other payment provider functionality, such as payment provider account control and monitoring, as well as payment.

The system can include a social network 150. For example, the system can include a social network 150 such as Facebook. The receiving user can check in with a merchant via the social network 150. By checking in with the merchant via the social network 150, the receiving user can inform the social network 150, and consequently friends of the receiving user, that the receiving user is at a store of the merchant and/or is shopping with the merchant. The merchant can be a brick-and-mortar merchant, an online merchant, or any other type of merchant.

The system can include a payment server 130. The payment server 130 can be a server of a payment provider, such as Paypal, Inc. The payment server 130 can administer the virtual gift card system and method. Thus, the payment server 130 can administer the virtual gift card purchase process and the virtual gift card giving or delivery process. The payment server 130 can administer use or transfer (such as from one receiving user to another receiving user) of the virtual gift card.

The payment server 130 can be a single server or can be a plurality of servers. The payment server 130 can include one or more processors 131 and a memory 132. The memory 132 can be a memory of the payment server 130 or a memory that is associated with the payment server 130. The memory 132 can be a distributed memory. The memory 132 can store a giving user's account 133, a receiving user's account 134 and a merchant's account 135.

The merchant device 110, the giving user's mobile device 120, the receiving user's mobile device 140, the payment server 130, and the social network 150 can communicate with one another via a network, such as the Internet 140. The merchant device 110, the mobile device 120, the receiving user's mobile device 140, the payment server 130, and the social network 150 can communicate with one another via a plurality of networks, such as local area networks (LANs), wide area networks (WANs), the Internet, cellular telephone networks, and the like.

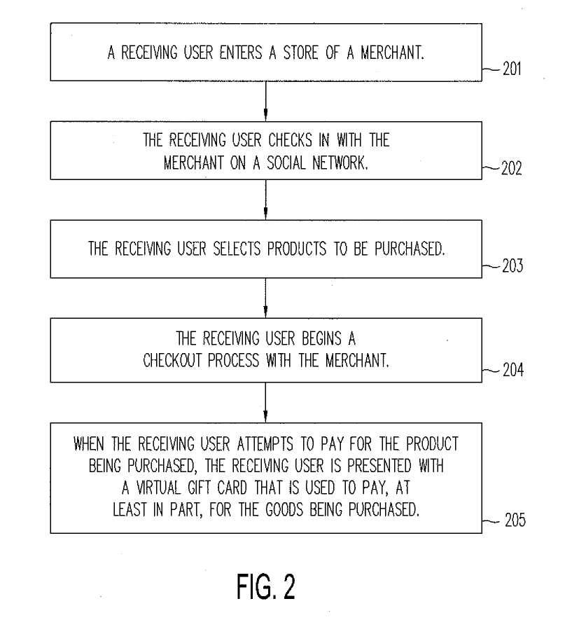

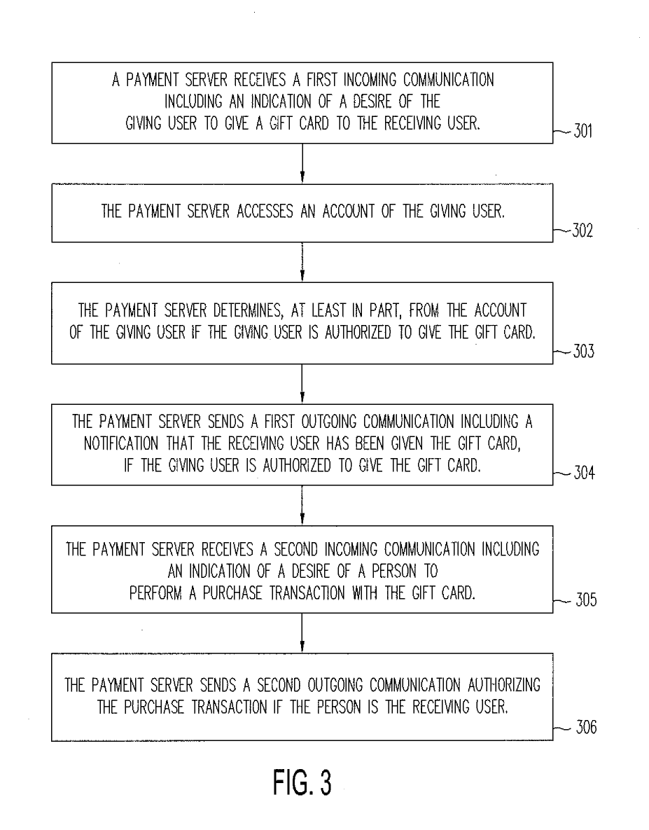

FIGS. 2 and 3 are flow charts that describe examples of operation of the system for facilitating the sale and use of virtual gift cards according to embodiments thereof. Note that one or more of the steps described herein may be combined, omitted, or performed in a different order, as desired or appropriate.

FIG. 2 is a flow chart showing a method for facilitating the sale and use of virtual gift cards, according to an embodiment. A receiving user can enter a store of a merchant, as shown in step 201. The receiving user can, for example, enter a store at a mall or shopping center, or can enter any other store. The store can be a retail store, a restaurant, an automotive garage, or any other type of store. The store can be any place that sells something, e.g., any place where a product or service can be purchased.

The receiving user can check in with the merchant via the social network 150, as shown in step 202. By checking in with the merchant via the social network 150, the receiving user can inform friends of the receiving user that the receiving user is shopping at a store of the merchant. Thus, the friends of the user can be aware of the opportunity to purchase the receiving user a virtual gift certificate.

The receiving user and the giving user can both belong to the same social network 150. For example, the receiving user and the giving user can both belong to Facebook. By checking in with the merchant, the receiving user can let the giving user know that the receiving user is in the store. Thus, the giving user is provided with an opportunity to purchase a virtual gift card for the receiving user.

In this manner the giving user can review information regarding the receiving user, such as via the social network 150, to become aware that the receiving user is shopping at the store of the merchant. The giving user can receive a notification, such as from the social network 150, that the receiving user is checked in with the merchant. The receiving user can inform the giving user that the receiving user is at the store of the merchant or will be at the store of the merchant.

The giving user can prearrange, such as with the social network 150, to receive a notification when the receiving user checks in with a merchant. The giving user can prearrange to receive a notification when the receiving user checks in with a particular or specified merchant. For example, the giving user can prearrange to receive a notification when the receiving user checks in with a merchant that accepts virtual gift cards from the payment provider. The giving user can prearrange to receive a notification when the receiving user checks in with any merchant.

The receiving user can select one or more products to be purchased, as shown in step 203. For example, the receiving user can shop and select products as the receiving user intended to do at the store. The receiving user can be unaware that the giving user is considering giving the receiving user a virtual gift certificate or that the giving user has already given the receiving user a virtual gift certificate.

The receiving user can begin a checkout process with the merchant, as shown in step 204. For example, the receiving user can bring a shopping basket of products to a checkout counter of the store and a checkout clerk can begin to scan the products for checkout.

When the receiving user attempts to pay for the products being purchased, the receiving user can be presented with a virtual gift card that can be used to pay, at least in part, for the goods being purchased, as shown in step 205. For example, the receiving user can present the checkout clerk with a card, such as a payment provider card or credit card. When the card is swiped, then the checkout clerk and/or the receiving user can be notified that a virtual gift card has been given to the receiving user. The receiving user can be given a choice regarding whether or not to apply the virtual gift card to the purchase. If the receiving user chooses to use apply the virtual gift card to the purchase, then an amount of the virtual gift card, up to an amount of the purchase, can be applied to the purchase. Thus, the amount that the receiving user must pay for the purchase can be reduced correspondingly.

Alternatively, the virtual gift card can be automatically applied to the purchase. The giving user can specify, such as when purchasing the virtual gift card, whether the virtual gift card is to be automatically applied to the purchase or the receiving user is given the choice of whether or not to apply the virtual gift card to the purchase.

Presentation of the virtual gift card to the receiving user can be accompanied by fanfare. For example, when the receiving user attempts to pay for the purchase at the checkout counter, lights can flash, buzzers or bells can sound, music can be played (such as the Happy Birthday song, for example). Thus, the music can be appropriate with respect to the message and/or the occasion. The merchant can provide the receiving user with additional items such as discounts, products, coupons, promotional items, or the like. Such additional items can tend to encourage use of the payment provider, the social network 150, the merchant, or anything else.

The receiving user can pay for the purchase solely with the virtual gift card. The receiving user can pay for the purchase with any desired combination of the virtual gift card, a credit card, cash, or any other mechanism or instrument. Since the receiving user has received the virtual gift card and does not need to spend as much money as anticipated, the receiving user can purchase additional products, if desired. For example, the receiving user can take advantage of any additional discounts, as discussed above.

The receiving user can be notified, such as via a text message, email, or voice using the receiving user's mobile device 140, that the virtual gift card has been given. The receiving user can be notified of the amount of the virtual gift card in this manner. The giving user can send the receiving user a message in this manner. The payment server 130 can send the receiving user a message in this manner. For example, the giving user can wish the receiving user a happy birthday in the message. Any limitations or suggestions regarding use of the virtual gift card can be included in the message.

The giving user can be notified when the receiving user uses the virtual gift card. The receiving user can be given an opportunity to thank the giving user for the virtual gift card. For example, the receiving user can easily thank the giving user for the virtual gift card by merely checking a box using the payment provider app 144 of the receiving user's mobile device 140.

FIG. 3 is a flow chart showing further detail of the method for facilitating the sale and use of virtual gift cards, according to an embodiment. A payment server can receive a first incoming communication including an indication of a desire of the giving user to give a gift card to the receiving user, as shown in step 301. The gift card can be a virtual gift card. The gift card can be a physical gift card, similar in appearance and use to a credit card. The gift card can be any type of gift card. Generally, a virtual gift card can be purchased for any merchant that uses a payment service that is associated with or that operates in cooperation with the payment server 130.

The virtual gift card can be given to an individual person, a group of people, a company, or any other entity. For example, the virtual gift card can be given to a family, such that any member of the family can use the virtual gift card. The gift card can be given to a group of people that are otherwise not substantially associated with one another. For example, the giving user can define a list of receiving users and the list can contain any people that the giving user desires.

The virtual gift card can be given by an individual person, a group of people, a company, or any other entity. For example, the virtual gift card can be given by a business to employees of the business. The gift card can be given by a computer or other machine.

The virtual gift card can be given to a randomly chosen person. For example, a computer or other machine can randomly choose one or more people to receive virtual gift cards. In this mariner, virtual gift cards can be given as prizes in a contest, as promotional items, or for any other reason.

The payment provider can offer a premium to giving users and/or receiving users, such as to promote use of the payment provider. For example, the payment provide can offer virtual gift cards, cash discounts, and the like to giving users and/or receiving users who purchase a given number or a given value of virtual gift cards, such as within a predetermined period of time (i.e., a month or a year).

The virtual gift card can be used with both brick-and-mortar merchants and online merchants. For example, the virtual gift card can be used with ETSY, eBay, and eBay vendors, e.g., eBay associate sellers.

The virtual gift card system can be compatible with a Paypal wallet or the like. For example, the virtual gift card can be paid for via a Paypal wallet of the giving user and can be added to the Paypal wallet of the receiving user.

The first incoming communication can be from the giving user's mobile device 120, for example. The first incoming communication can be from a non-mobile device such as the giving user's desktop computer. The first incoming communication can be from any device from which the giving user can send the first incoming communication.

The payment server 130 can access the giving user's account 133, as shown in step 302. For example, the payment server 130 can access the giving user's account 133 in the memory 132 of the payment server 130.

The payment server 130 can determine, at least in part, from the giving user's account 133 if the giving user is authorized to give the virtual gift card, as shown in step 303. For example, the payment server 130 can determine, at least in part, if the giving user has sufficient funds or sufficient credit in the giving user's account 133 to pay for the virtual gift card.

A plurality of giving users can cooperate to purchase the virtual gift card for the receiving user. Thus, the cost to each giving user for a virtual gift card of set amount is reduced correspondingly. For example, four giving users can cooperate to purchase a virtual gift card of $100 by contributing $25 each.

The payment server 130 can optionally access the receiving user's account 134. For example, the payment server 130 can access the receiving user's account 134 in the memory 132 of the payment server 130. For example, the payment server 130 can determine, at least in part from the receiving user's account 134, if the receiving user is permitted to receive virtual gift cards. In this manner, a parent can restrict a child from receiving virtual gift cards or the parent can control from whom the child is permitted to receive virtual gift cards.

Thus, accounts of the payment provider, such as the receiving user's account, can have restrictions placed thereon. As a further example, a parent can restrict a child from receiving virtual gift cards without the parent's approval. The parent's approval can be provided beforehand for designated giving users. The parent's approval can be provided on an ad hoc or case-by-case basis.

The payment server 130 can send a first outgoing communication including a notification that the receiving user has been given the virtual gift card, if the giving user is authorized to give the virtual gift card, as shown in step 304. The first outgoing communication can be sent to the receiving user, the merchant, and/or anyone else. In this manner, the receiving user can be given the virtual gift card from the giving user. The first outgoing communication, e.g., the virtual gift card, can be sent to the merchant device 110, the receiving user's device, 120, or both the merchant device 110, the receiving user's device, 120. For example, the virtual gift card may be sent as soon as the giving user purchases the virtual gift card or when the giving user is at some stage of a checkout process (e.g., beginning, during, or end). In the latter case, if the receiving user knows a virtual gift card is available, the receiving user may select items for purchase the receiving user may not have intended before.

The first outgoing communication can include a message from the giving user. For example, the first outgoing communication can include an occasion specific message such as “Happy Birthday!” from the giving user. The message can include any limitations or suggestions regarding use of the virtual gift card, as discussed herein.

The payment server can receive a second incoming communication including an indication of a desire of a person to perform a purchase transaction with the virtual gift card, as shown in step 305. The second incoming communication can result from the receiving user initiating a payment transaction with the merchant, such as by presenting a card that is swiped by the checkout clerk. Rather than accepting payment via the swiped card, the payment server 130 can take the payment or partial payment from the virtual gift card of the receiving user. Optionally, the receiving user can be given a choice regarding whether payment is to be made via the swiped card or the virtual gift card, as discussed herein.

The payment server 130 can send a second outgoing communication authorizing the purchase transaction if the person making the purchase is the receiving user, as shown in step 306. The second outgoing communication can be sent to the receiving user, the merchant, and/or anyone else. The receiving user can be required to enter a personal identification number (PIN) that is verified by the payment server 130. In this manner, the payment server 130 can determine whether or not the person making the purchase is the receiving user.

The virtual gift card can include information representative of various other limitations. For example, the virtual gift card can be limited to use at a specified store, a specified group of stores, or a specified chain of stores. The virtual gift card can be limited to use in purchasing a specified product. The virtual gift card can be limited to use geographically. For example, the virtual gift card can be limited to use within a specified city or group of cities, within a specified state or group of states, within a specified country or group of countries, and/or at any location or group of locations. The virtual gift card can be limited to use temporally. For example, the virtual gift card can be limited to use on weekdays, on weekends, from 11:00 AM to 1:00 PM on weekdays, and/or at any other time.

The virtual gift card can be specified for use by a one or more people, one or more entities, or any combination thereof. For example, the virtual gift card can be specified for use by a person named John Doe, as well as specified employees of John Doe's business. As a further example, the virtual gift card can be specified for use by any of the employees of International Business Machines Corporation (IBM).

The virtual gift card can expire after a specified amount of time. For example, the virtual gift card can expire after one day, five days, one week, three weeks, or one month from the date of issuance. The giving user can specify a date, e.g., 25 Mar. 2025, on which the virtual gift card expires. The giving user can specify a duration, e.g., one year, for which the virtual gift card is usable. Alternatively, the payment provider or another business entity can determine when the virtual gift card expires.

The virtual gift card can have a different value depending on any specified criteria. For example, the virtual gift card can decline or increase in value from the date of issuance until a specified date in the future. The virtual gift card can have one value if used at a specified store and another value if used at any other store. The virtual gift card can have one value if used to purchase a specified product and another value if used to purchase any other product.

A limit can be placed on how quickly the virtual gift card can be spent. For example, the virtual gift card can be limited to purchases totaling $50 per day, purchases totaling $600 per week, or purchases totaling $2,000 per month.

Products can be specified for which the virtual gift card cannot be used to purchase. For example, a limitation upon the use of the virtual gift card can specify that the virtual gift card cannot be used for the purchase of alcohol or cigarettes. Rather than not allowing such items altogether, a limit can be placed on the amount of such purchases in a given time period. For example, $20 worth of beer and $10 worth of cigarettes can be purchased in one week.

Contingent limitations can be provided. For example, the receiving user can be permitted to purchase $10 worth of cigarettes each week only if no alcohol has been purchased. As a further example, the receiving user can be permitted to purchase alcohol only on weekends.

Specified purchases or types of purchase can require permission. These purchases can require permission from the giving user or from someone specified by the giving user. For example, purchases of alcohol and cigarettes can require that the receiving user contact the giving user, such as via cellular telephone, email, or text messaging, and request authorization to make the purchase. The giving user can then use the payment provider app 124 to authorize the purchase, if desired. The payment provider app 124 can, for example, communicate the authorization to the payment server and the payment server 131 can communicate the authorization to the receiving user's mobile device 140 or the merchant device 110 at the store 101 where the purchase is desired.

The virtual gift card system can check the age of the receiving user. If the receiving user is under the legal age for purchasing particular items, then the virtual gift card system can automatically limit use of the virtual gift card such that the particular items cannot be purchased with the virtual gift card. The virtual gift card system can check the age of the receiving user by accessing a database where this information is stored or by querying the giving user. The giving user can specify the birth dates of potential virtual gift card receiving users during a setup procedure of the virtual gift card system.

On a birthday, holiday, or other event, or at a predetermined time before the event, the virtual gift card system can remind potential giving users, e.g., social network friends of the receiving user, of the upcoming event and can query the potential giving users to see if any of the potential giving users would like to have a virtual gift card issued due to the event. For example, two weeks before a potential giving user's wife's birthday, the virtual gift card system can send a text message, email, or other communication to the potential giving user to see if the potential giving user would like to have a virtual gift card issued to the potential giving user's wife.

Any combination of limits can be specified for the virtual gift card. The limits can be changed after the virtual gift card is issued. According to an embodiment, changing the limits can only be done by the giving user or by a person specified by the giving user. For example, the giving user can specify that the giving user's wife can change limits for virtual gift cards given to the giving user's children.

The giving user can provide suggestions for the use of the virtual gift card. Such suggestions can be included in the message to the receiving user. The message can be included in the virtual gift card, e.g., can be part of the virtual gift card. The message can be communicated to the receiving user via telephone, text messaging, email, or any other method. The message can announce that the receiving user is receiving the virtual gift card, provide the money amount of the virtual gift card, and list any limitations or suggestions regarding the virtual gift card. Generally, anything that can be a limit can be a suggestion and visa versa.

The limits or suggestions can change automatically in response to various criteria. The limits or suggestions can change automatically in response to a change the law. For example, a user specified limit affecting the receiving user's ability to purchase alcohol or cigarettes with the virtual gift card can change automatically due to a change in the legal age for purchasing alcohol or cigarettes when the change in the law goes into effect. The limits or suggestions can change automatically in response to a change the marketplace. For example, a suggestion regarding what to purchase or where to purchase can change automatically in response to the opening or closing of a store or in response to a change in the availability of a product. Such automatic changes in limits or suggestions can be effected by the payment server 130, which can monitor the criteria, such as via the Internet and/or via connection to the relevant databases.

In implementation of the various embodiments, embodiments of the invention may comprise a personal computing device, such as a personal computer, laptop, PDA, cellular phone or other personal computing or communication devices. The payment provider system may comprise a network computing device, such as a server or a plurality of servers, computers, or processors, combined to define a computer system or network to provide the payment services provided by a payment provider system.

In this regard, a computer system may include a bus or other communication mechanism for communicating information, which interconnects subsystems and components, such as a processing component (e.g., processor, micro-controller, digital signal processor (DSP), etc.), a system memory component (e.g., RAM), a static storage component (e.g., ROM), a disk drive component (e.g., magnetic or optical), a network interface component (e.g., modem or Ethernet card), a display component (e.g., CRT or LCD), an input component (e.g., keyboard or keypad), and/or cursor control component (e.g., mouse or trackball). In one embodiment, a disk drive component may comprise a database having one or more disk drive components.

The computer system may perform specific operations by processor and executing one or more sequences of, one or more instructions contained in a system memory component. Such instructions may be read into the system memory component from another computer readable medium, such as static storage component or disk drive component. In other embodiments, hard-wired circuitry may be used in place of or in combination with software instructions to implement the invention.

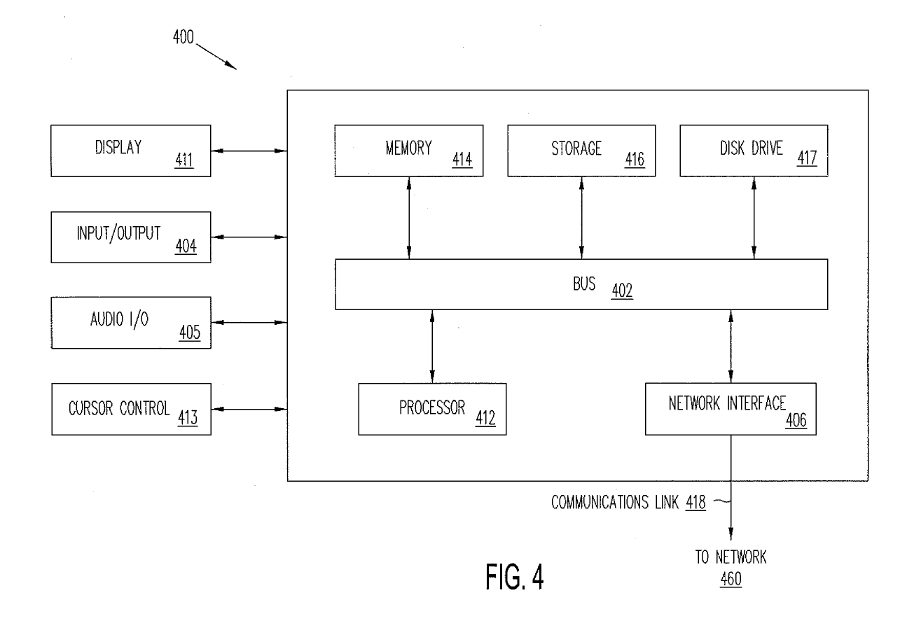

FIG. 4 is a block diagram of a computer system 400 suitable for implementing one or more embodiments of the present disclosure. In various implementations, the PIN pad and/or merchant terminal may comprise a computing device (e.g., a personal computer, laptop, smart phone, tablet, PDA, Bluetooth device, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the giving user, for example, to hear audio. A transceiver or network interface 406 transmits and receives signals between computer system 400 and other devices, such as a user device, a merchant server, or a payment provider server via network 460. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable and executable media include, for example, floppy disk, flexible disk, hard disk, magnetic tape, any other magnetic medium, CD-ROM, any other optical medium, punch cards, paper tape, any other physical medium with patterns of holes, RAM, ROM, E2PROM, FLASH-EPROM, any other memory chip or cartridge, carrier wave, or any other medium from which a computer is adapted to read.

In various embodiments, execution of instruction sequences for practicing the invention may be performed by a computer system. In various other embodiments, a plurality of computer systems coupled by a communication link (e.g., LAN, WLAN, PTSN, or various other wired or wireless networks) may perform instruction sequences to practice the invention in coordination with one another.

Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa—for example, a virtual Secure Element (vSE) implementation or a logical hardware implementation.

Software, in accordance with the present disclosure, such as program code and/or data, may be stored on one or more computer readable and executable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The virtual gift card can be either transferable or not transferable. If the virtual gift card is transferable, then it can only be transferable to members of the same social network 150 and/or users of the same payment provider. Alternatively, the virtual gift card can be transferable to members of a different social network and/or users of a different payment provider. As a further alternative, the virtual gift card can be transferable to receiving users who are not members of any social network and/or are not users of the any payment provider.

The virtual gift card can be accompanied by or evidenced by a physical gift card or other physical device or items, such as a certificate. Generally, no physical gift card is necessary and thus is not used. The merchant device 110, or a computer can print a statement that provides information regarding the virtual gift card. For example, the statement can include the original amount of the virtual gift card, any remaining balance for the virtual gift card, an itemized list of items purchased and their purchase prices, dates of purchase, and places of purchase. The statement can include a listing of any messages, limitations, or suggestions regarding the virtual gift card.

As used herein, the term “store” can include any business or place of business. The store can be a brick-and-mortar store or an online store. The store can be any person or entity that sells a product.

As used herein, the term “product” can include any item or service. Thus, the term “product” can refer to physical products, digital goods, services, or anything for which a user can make a payment, including charitable donations. A product can be anything that can be sold.

As used herein, the term “merchant” can include any seller of products. The term merchant can include a store. The products can be sold from a store or in any other manner.

As used herein, the term “mobile device” can include any portable electronic device that can facilitate data communications, such as via a cellular network and/or the Internet. Examples of mobile devices include cellular telephones, smart phones, tablet computers, and laptop computers.

As used herein, the term “virtual gift card” can include a gift card that lacks a physical embodiment such as a card or security token. However, the virtual gift card can include such a physical embodiment. The term “virtual gift card” can include a gift card that can be purchased electronically, e.g., online or with an app and/or that can be given electronically. Generally, it is not necessary for the receiving user to possess a physical embodiment of the virtual gift card in order to purchase products with the virtual gift card.

As discussed herein, a simple, easy, and convenient way to purchase and give gift cards is provided. Virtual gift cards can be purchased and given without the purchaser leaving the purchaser's house. Additionally, virtual gift cards can be purchased quickly, e.g., almost instantaneously.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. Having thus described various example embodiments of the disclosure, persons of ordinary skill in the art will recognize that changes may be made in form and detail without departing from the scope of the invention. Thus, the invention is limited only by the claims.

1. A system comprising:
a memory storing account information for a plurality of users, the account information including information regarding a giving user and a receiving user;
one or more processors configured to:
send a notification to the giving user that the receiving user is at a merchant location;
receive a first incoming communication including an indication of a desire of the giving user to give a gift card to the receiving user;
access the giving user's account;
determine, at least in part, from a giving user's account if the giving user is authorized to give the gift card; and
send a first outgoing communication including a notification that the receiving user has been given the gift card, if the giving user is authorized to give the gift card, wherein the gift card is only usable with a merchant where the receiving user was checked in with a social network when the gift card was given and wherein the gift card is only usable only for a limited time after the gift card was given.

2. The system of claim 1, wherein the one or more processors are further configured to:
receive a second incoming communication including an indication of a desire of a person to perform a purchase transaction with the gift card; and
send a second outgoing communication authorizing the purchase transaction if the person is the receiving user.

3. The system of claim 1, wherein the one or more processors are further configured to:
receive a second incoming communication including an indication of a desire of a person to make a purchase transaction with the gift card and including a personal identification number (PIN) of the person; and
send a second outgoing communication authorizing the person to complete the purchase transaction based, at least in part, on whether the PIN is the PIN of the receiving user.

4. The system of claim 1, wherein the one or more processors are further configured to facilitate automatically applying the gift card during checkout.

5. (canceled)

6. The system of claim 1, wherein at least one of the first outgoing communication and the second outgoing communication includes a message from the giving user to the receiving user.

7. The system of claim 1, wherein:
the giving user and the receiving user are both members of a same social network;
the one or more processors are configured to determine, at least in part, from the social network what merchant the receiving user is checked in with via the social network; and
the one or more processors are configured to provide authorization for the receiving user to complete a purchase transaction using the gift card only with the merchant which the user was checked in with via the social network when the first outgoing communication was sent.

8. A method comprising:
sending, electronically by one or more processors, a notification to a giving user that a receiving user is at a merchant location;
receiving, by the one or more processors, a first incoming communication including an indication of a desire of the giving user to give a gift card to the receiving user;
accessing, by the one or more processors, a giving user's account;
determining, by the one or more processors, at least in part from the giving user's account, if the giving user is authorized to give the gift card;
sending, by the one or more processors, a first outgoing communication including a notification that the receiving user has been given the gift card, if the giving user is authorized to give the gift card; and
monitoring, by the one or more processors, at least one of a law and a marketplace for changes related to the gift card.

9. The method of claim 8, further comprising:
receiving, by the one or more processors, a second incoming communication including an indication of a desire of a person to perform a purchase transaction with the gift card; and
sending, by the one or more processors, a second outgoing communication authorizing the purchase transaction if the person is the receiving user.

10. The method of claim 8, further comprising:
receiving, by the one or more processors, a second incoming communication including an indication of a desire of a person to make a purchase transaction with the gift card and including a personal identification number (PIN) of the person; and
sending, by the one or more processors, a second outgoing communication authorizing the person to complete the purchase transaction based, at least in part, on whether the PIN is the PIN of the receiving user.

11. (canceled)

12. The method of claim 8, wherein the gift card is only usable with a merchant where the receiving user was checked in with a social network when the gift card was given.

13. (canceled)

14. The method of claim 8, wherein the giving user and the receiving user are both members of a same social network and further comprising:
determining, by the one or more processors, at least in part from the social network, what merchant the receiving user is checked in with via the social network; and
providing authorization, by the one or more processors, for the receiving user to complete a purchase transaction using the gift card only with the merchant which the user was checked in with via the social network when the first outgoing communication was sent.

15. A computer program product comprising a non-transitory computer readable medium having computer readable and executable code for instructing one or more processors to perform a method, the method comprising:
sending a notification to a giving user that a receiving user is at a merchant location;
receiving a first incoming communication including an indication of a desire of the giving user to give a gift card to the receiving user;
accessing a giving user's account;
determining, at least in part from the giving user's account, if the giving user is authorized to give the gift card;
sending a first outgoing communication including a notification that the receiving user has been given the gift card, if the giving user is authorized to give the gift card; and
monitoring at least one of a law and a marketplace for changes related to the gift card.

16. The computer program product of claim 15, wherein the method further comprises:
receiving a second incoming communication including an indication of a desire of a person to perform a purchase transaction with the gift card; and
sending a second outgoing communication authorizing the purchase transaction if the person is the receiving user.

17. (canceled)

18. The computer program product of claim 15, wherein the method further comprises automatically applying the gift card during checkout.

19. The computer program product of claim 15, wherein the gift card is only usable with a merchant where the receiving user was checked in with a social network when the gift card was given

20. The computer program product of claim 15, wherein at least one of the first outgoing communication and the second outgoing communication includes a message from the giving user to the receiving user.

21. The computer program product of claim 15, wherein the giving user and the receiving user are both members of a same social network and further comprising:
determining, at least in part from the social network, what merchant the receiving user is checked in with via the social network; and
providing authorization for the receiving user to complete a purchase transaction using the gift card only with the merchant which the user was checked in with via the social network when the first outgoing communication was sent.

22. The method of claim 8, further comprising:
effecting a change in the gift card in response to a change in the law after the gift card has been given.

23. The method of claim 22, wherein the change in the law comprises a change in a legal age for purchasing a product.

24. The computer program product of claim 15, further comprising:
effecting a change in the gift card in response to a change in the marketplace after the gift card has been given.

25. The computer program product of claim 24, wherein the change in the marketplace comprises a change in an availability of a product.
